(19) United States
(12) Patent Application Publication
(10) Pub. No.: US 2014/0153242 A1
(43) Pub. Date: Jun. 5, 2014

(54) Aerodynamic LED Light Fixture

(71) Applicant: Cree, Inc., Durham, NC (US)

(72) Inventors: Alan J. Ruud, Racine, WI (US); Kurt S. Wilcox, Libertyville, IL (US); Steven R. Walczak, Kenosha, WI (US)

(21) Appl. No.: 13/908,530

(22) Filed: Jun. 3, 2013

Related U.S. Application Data
(63) Continuation of application No. 11/864,298, filed on Sep. 28, 2007, now abandoned.
Application No. 11/864,298 is a continuation-in-part of application No. 13/834,525, filed on Mar. 15, 2013.
Application No. 13/834,525 is a continuation of application No. 13/294,459, filed on Nov. 11, 2011, now Pat. No. 8,425,071.
Application No. 13/294,459 is a continuation of application No. 12/629,986, filed on Dec. 3, 2009, now Pat. No. 8,070,306.
Application No. 12/629,986 is a continuation of application No. 11/860,887, filed on Sep. 25, 2007, now Pat. No. 7,686,469.
Application No. 11/860,887 is a continuation-in-part of application No. 11/541,908, filed on Sep. 30, 2006, now abandoned.

(51) Int. Cl. F21S 8/04; F21V 29/00; F21K 99/00

(52) U.S. Cl. CPC F21S 8/043; F21K 9/00; F21V 29/004; F21V 29/22
USPC 362/249.02

(57) ABSTRACT

An LED light fixture having a light-emitting region and a perimetrical structure therearound. The light-emitting region includes at least one LED-array module supported by an LED heat sink open for air/water-flow. The perimetrical structure has first and second opposite substantially-aligned edge-adjacent portions each extending along the light-emitting region and meeting each other at a perimetrical edge. The first and second edge-adjacent portions converge toward each other at positions progressively closer to the perimetrical edge to form aerodynamic-drag-reducing cross-sectional profiles transverse to the fixture plane and extending in substantially all fixture-plane directions from the intersection of its two major principal axes.

### RELATED APPLICATION

This application is a continuation of patent application Ser. No. 11/864,298, filed Sep. 28, 2007. This application is also a continuation-in-part of patent application Ser. No. 13/834,525, filed Mar. 15, 2013, which is a continuation of patent application Ser. No. 13/294,459, filed Nov. 11, 2011, now U.S. Pat. No. 8,425,071, issued Apr. 23, 2013, which is a continuation of patent application Ser. No. 12/629,986, filed Dec. 3, 2009, now U.S. Pat. No. 8,070,306, issued Dec. 6, 2011, which is a continuation of patent application Ser. No. 11/860,887, filed Sep. 25, 2007, now U.S. Pat. No. 7,686,469, issued Mar. 30, 2010, which is a continuation-in-part of now abandoned patent application Ser. No. 11/541,908, filed Sep. 30, 2006. The entire contents of each of the parent applications are incorporated herein by reference.

### FIELD OF THE INVENTION

This invention relates to lighting fixtures and, more particularly, to light fixtures using LED modules.

### BACKGROUND OF THE INVENTION

In recent years, the use of light-emitting diodes (LEDs) for various common lighting purposes has increased, and this trend has accelerated as advances have been made in LEDs and in LED arrays, often referred to as “LED modules.” Indeed, lighting applications which previously had been served by fixtures using what are known as high-intensity discharge (HID) lamps are now beginning to be served by fixtures using LED-array-bearing modules. Such lighting applications include, among a good many others, roadway lighting, factory lighting, parking lot lighting and commercial building lighting.

Work continues in the field of LED module development, and also in the field of using LED modules for various lighting fixtures in various applications. It is the latter field to which this invention relates. Floodlights using LED modules as light source for various applications present particularly challenging problems in fixture development, particularly when floodlight mounting locations and structures will vary. Lighting-fixture adaptability is an important goal for LED floodlights that are often presented and mounted in different ways.

Heat dissipation is another problem for LED floodlights. And, the goals of dealing with heat dissipation and protection of electronic LED drivers can often be conflicting, contrary goals.

Wind load is another problem for LED floodlights and floodlights that are mounted on poles in general. Calculating wind loads is an important factor in the design of a wind force-resisting system for use in floodlights. This includes the design of fixture structural members and components against wind problems such as overturning and uplift actions.

Streamlined lighting fixtures provide several advantages given their traditional “slim” design. Lighting fixtures that are designed in an aerodynamic fashion not only decrease the wind load that is placed on the fixture but also decrease rattling and other wind-generated disturbances. Some LED floodlights of the prior art are bulky in size. Given their bulky nature these floodlights are very susceptible to wind load damage.

In short, there is a significant need in the lighting industry for improved floodlight fixtures using modular LED units—fixtures that are adaptable for a wide variety of mountings and situations, and that satisfy the problems associated with wind load in all directions. Finally, there is a need for an improved LED-module-based floodlight which is easy and inexpensive to manufacture.

### OBJECTS OF THE INVENTION

It is an object of the invention to provide an improved LED floodlight fixture that overcomes some of the problems and shortcomings of the prior art, including those referred to above.

Another object of the invention is to provide an improved LED floodlight fixture that is readily adaptable for a variety of mounting positions and situations. Another object of the invention is to provide an improved LED floodlight that reduces development and manufacturing costs for LED floodlight for different floodlight applications.

Another object of the invention is to provide an improved LED floodlight with aerodynamic properties subjecting it to less wind load when mounted on a pole or similar mounting.

How these and other objects are accomplished will become apparent from the following descriptions and the drawings.

### SUMMARY OF THE INVENTION

The present invention is an improvement in LED floodlight fixtures. The inventive LED floodlight fixture includes two major principal axes in a plane, and the dimensions parallel to its third principal axis are substantially smaller than the largest dimensions parallel to the plane. The fixture is characterized by a first outer surface which has a central portion and a first edge-adjacent portion, an opposite second outer surface which has a light-emitting region and a second edge-adjacent portion. The first and second edge-adjacent portions meet at a perimetrical edge. The central portion and the light-emitting region each extend across at least 50% of the area within the perimetrical edge. The first and second edge-adjacent portions form aerodynamic-drag-reducing cross-sectional profiles transverse to the plane and extend in substantially all in-plane directions. The greatest dimension between the first central portion and the reference plane is no more than 50% greater than the smallest dimension therebetween.

In some highly preferred embodiments, each of the aerodynamic-drag-reducing cross-sectional profiles have an aspect ratio of about 3 or less. It is preferred that the aspect ratio is about 1.25 or less.

In certain preferred embodiments, the cross-sectional profiles are substantially the same. It is preferable that at least one of the edge-adjacent portions is substantially convex. In other preferred embodiments, both the edge-adjacent portions are substantially convex.

In certain preferred embodiments, the LED floodlight fixture includes a pole-mounting assembly which attaches the fixture to a light pole. Such pole-mounting assembly preferably includes a pole-attachment portion for receiving and securing a pole and a substantially water/air-tight section enclosing electrical connections (not shown).

The inventive LED floodlight fixture includes a housing forming a substantially water/air-tight chamber, at least one electronic LED driver enclosed within the chamber, and an LED assembly secured with respect to the housing adjacent thereto in non-water/air-tight condition, the LED assembly having at least one LED-array module mounted on an LED heat sink.

The housing preferably includes substantially water/air-tight wire-access(es) for passage of wires between the LED assembly and the water/air-tight chamber.

The housing includes a first border structure forming a first border-portion of the chamber, the first border structure receiving wires from the at least one LED-array module and the LED heat sink being interlocked with the first border structure. The housing further includes a frame structure forming a frame-portion of the chamber secured to the first border structure, the frame structure extending along the LED assembly. It is highly preferred that the border structure is a metal extrusion.

In some preferred embodiments, the first border structure has at least one bolt-receiving border-hole through the first border structure, such border-hole being isolated from the first border-portion of the chamber. The frame structure also has at least one bolt-receiving frame-hole through the frame structure, the frame-hole being isolated from the frame-portion of the chamber. Each such one or more frame-holes are aligned with a respective border-hole(s). A bolt passes through each aligned pair of bolt-receiving holes such that the border structures and the frame structure are bolted together while maintaining the water/air-tight condition of the chamber.

In some highly preferred embodiments, the housing includes a second border structure forming a second border-portion of the chamber, the LED heat sink being interlocked with the second border structure. In such embodiments, the frame structure is secured to the first and second border structures.

The frame structure preferably includes an opening edge about the frame-portion of the chamber. A removable cover-plate is preferably in substantial water/air-tight sealing engagement with respect to the opening edge. Such opening edge may also have a groove configured for mating water/air-tight engagement with the border structure(s). It is preferred that one or more electronic LED drivers are enclosed in the frame-portion of the chamber.

In certain preferred embodiments the frame structure preferably includes a vent permitting air flow to and from the LED assembly. Such venting facilitates cooling the LED assembly.

In certain highly preferred embodiments of this invention, including those used for street lighting and the like, the housing is a perimetrical structure such that the substantially water/air-tight chamber substantially surrounds the LED assembly. The perimetrical structure is preferably substantially rectangular and includes the first and second border structures and a pair of opposed frame structures each secured to the first and second border structures.

In some versions of the inventive LED floodlight fixture, the housing is a perimetrical structure configured for wall mounting and includes the first and second border structures on opposed perimetrical sides and the frame structure secured on a perimetrical side between the border structures.

In certain highly preferred embodiments of the inventive LED floodlight fixture, the LED assembly includes a plurality of LED-array modules each separately mounted on its corresponding LED heat sink, the LED heat sinks being interconnected to hold the LED-array modules in fixed relative positions. Each heat sink preferably includes a base with a back base-surface, an opposite base-surface, two base-ends and first and second base-sides, a female side-fin and a male side-fin, one along each of the opposite sides and each protruding from the opposite surface to terminate at a distal fin-edge. The female side-fin includes a flange hook positioned to engage the distal fin-edge of the male side-fin of an adjacent heat sink. At least one inner-fin projects from the opposite surface between the side-fins. One of the LED modules is against the back surface.

In some preferred embodiments, each heat sink includes a plurality of inner-fins protruding from the opposite base-surface. Each heat sink may also include first and second lateral supports protruding from the back base-surface, the lateral supports each having an inner portion and an outer portion, the inner portions of the first and second lateral supports having first and second opposed support-ledges, respectively, forming a heat-sink-passageway slidably supporting one of the LED-array modules against the back base-surface. The first and second supports of each heat sink are preferably in substantially planar alignment with the first and second side-fins, respectively. The flange hook is preferably at the distal fin-edge of the first side-fin.

It is highly preferred that each heat sink be a metal extrusion with the back base-surface of such heat sink being substantially flat to facilitate heat transfer from the LED-array module, which itself has a flat surface against the back-base surface.

Each heat sink also preferably includes a lateral recess at the first base-side and a lateral protrusion at the second base-side, the recesses and protrusions being positioned and configured for mating engagement of the protrusion of one heat sink with the recess of the adjacent heat sink.

In certain of the above preferred embodiments, the female and male side-fins are each a continuous wall extending along the first and second base-sides, respectively. It is further preferred that the inner-fins are also each a continuous wall extending along the base. The inner-fins can be substantially parallel to the side-fins.

In highly preferred embodiments, the LED floodlight fixture further includes an interlock of the housing to the LED assembly. The interlock has a slotted cavity extending along the housing and a cavity-engaging coupler which extends from the heat sink of the LED assembly and is received within the slotted cavity.

In some of such preferred embodiments, in each heat sink, at least one of the inner-fins is a middle-fin including a fin-end forming a mounting hole receiving a coupler. In some versions of such embodiments, the coupler has a coupler-head; and the interlock is a slotted cavity engaging the coupler-head within the slotted cavity. The slotted cavity preferably extends along the border structure and the coupler-head extends from the heat sink of the LED assembly.

In preferred embodiments of this invention, the LED floodlight fixture includes a restraining bracket secured to the housing. The bracket has a plurality of projections extending between adjacent pairs of fins of the heat sink, thus to secure the LED assembly. The restraining bracket preferably has a comb-like structure including an elongated body with a spine-portion from which identical side-by-side projections extend in a common plane. Such restraining bracket is configured and dimensioned for the elongated body to be fixedly secured to the housing and the projections to snugly fit in spaces between adjacent heat-sink fins, thus holding heat sink from moving.

The LED floodlight fixture further includes a mounting assembly secured to the housing. The mounting assembly preferably has a pole-attachment portion and a substantially water/air-tight section enclosing electrical connections with at least one wire-aperture communicating with the water/air-tight chamber. The housing is in water/air-tight engagement with the water/air-tight section of the pole-mounting assembly.

Preferably, the pole-mounting assembly has a mounting plate abutting the LED assembly, and at least one fastener/coupler extends from the mounting plate for engagement with the mounting hole of the middle-fin(s).

In certain embodiments of this invention, including those used for parking-structure lighting and the like, the frame structure is a sole frame structure, and the housing is a substantially H-shaped structure with the sole frame structure secured between mid-length positions of the pair of opposed border structures.

Some of the inventive LED floodlight fixtures include a protective cover extending over the LED assembly and secured with respect to the housing. Such protective cover preferably has perforations permitting air/water-flow therethrough for access to and from the LED assembly.

It is most highly preferred that the LED floodlight fixture has a venting gap between the housing and the LED assembly to permit water/air-flow from the heat sink The venting gap may be formed by the interlock of the housing to the LED assembly.

The improved LED floodlight fixture of this invention overcomes the problems discussed above. Among other things, the invention is both adaptable for varying applications and mountings, and given the aerodynamic features of the invention, it is not adversely affected by wind flowing past it (wind loads).

As used herein, the term “principal axes” refers to a set of mutually-perpendicular axes characterized by the following: (1) the origin of the axes is located generally centrally within the volume of the floodlight fixture; (2) a first axis is aligned with the largest dimension of the fixture; (3) a second axis is aligned with the largest dimension perpendicular to the first axis; and (4) the remaining (third) axis defines a direction in which thickness of the fixture is defined. The first and second axes as defined above together define a plane P, and fixture thickness is measured perpendicular to plane P. A simple graphical explanation of principal axes is shown in FIGS. 5 and 7, and the drawings illustrate fixture plane in perspective with lines 48, 50 both residing in fixture plane as illustrated in FIG. 1. Also as shown in FIG. 1, the perimetrical edge resides in the fixture plane.

As used herein, the term “aspect ratio” as applied to the aerodynamic-drag-reducing profiles formed by the first and second edge-adjacent portions of the floodlight fixture is the ratio of the maximum dimension d₃ as defined of the profile in a direction parallel to the third axis as defined above to the maximum dimension d_{P} of the profile in plane P as defined above. For an illustration of aspect ratio AR (AR=d₃/d_{P}) refer to FIGS. 8A-8E.

As used herein, the term “substantially convex” as applied to the aerodynamic-drag-reducing profiles refers to the shape of a portion of the profile as viewed from outside the fixture. A portion of the profile is substantially convex if all but small regions of the portion are convex, the small regions having locally non-convex portions to enable fastening or stiffening of the edge-adjacent portions. Such non-convex portions constitute less than 20% of the surface area of an edge-adjacent portion having substantially-convex profiles. The most preferred profile portions are generally smooth and convex everywhere along the profile portion.

As used herein, the term “encompassing” as applied to the second central portion encompassing the light-emitting region includes fixture configurations in which the light-emitting region has an area smaller than the second central portion as well as fixture configurations in which the light-emitting region has substantially the same area as the second central portion.

As used herein, the term “perimetrical structure” means an outer portion of the fixture which completely or partially surrounds remaining portions of the fixture. In certain preferred embodiments, such as those most useful for road-way lighting and the like, the perimetrical structure preferably completely surrounds remaining portions of the fixture. In certain other cases, such as certain wall-mounted floodlight fixtures, the perimetrical structure partially surrounds the remaining portions of the fixture.

The profile of an edge-adjacent portion of the floodlight fixture is considered to be aerodynamic-drag-reducing based on the fact that the aerodynamic drag forces (forces parallel to plane P) on the floodlight fixture from wind striking the fixture generally in plane P will be less than the drag forces which would be generated if the profile were simply a flat surface perpendicular to plane P and spanning the distance between the two boundaries of the two edge-adjacent portions as described above.

### BRIEF DESCRIPTION OF THE DRAWINGS

FIG. 1 is a perspective view of a preferred LED floodlight fixture in accordance with this invention configured for mounting on a pole.

FIG. 2 is a perspective view of the LED floodlight fixture of FIG. 1.

FIG. 3 is a side perspective view of the LED floodlight fixture of FIG. 1 including a pole-mounting assembly and a reference plane.

FIG. 4 is a perspective view of the LED floodlight fixture of FIG. 1 mounted to a light pole.

FIG. 5 illustrates the first major principal axes and the third principal axis of the LED floodlight fixture of FIG. 1.

FIG. 6 illustrates the two major principal axes of the LED floodlight fixture of FIG. 1.

FIG. 7 illustrates the second major principal axis and the third minor principal axis of the LED floodlight fixture of FIG. 1.

FIGS. 8A-8E illustrate various aerodynamic-drag-reducing cross-sectional profiles.

### DETAILED DESCRIPTION OF PREFERRED EMBODIMENTS

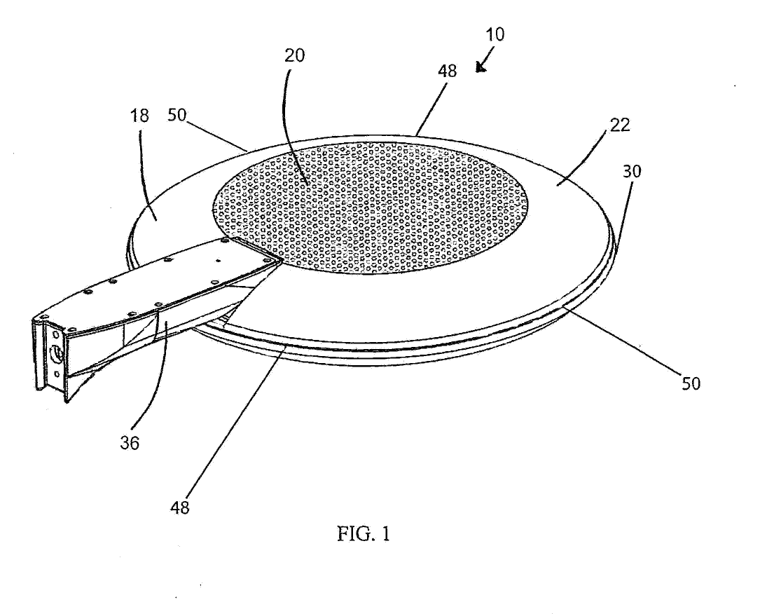

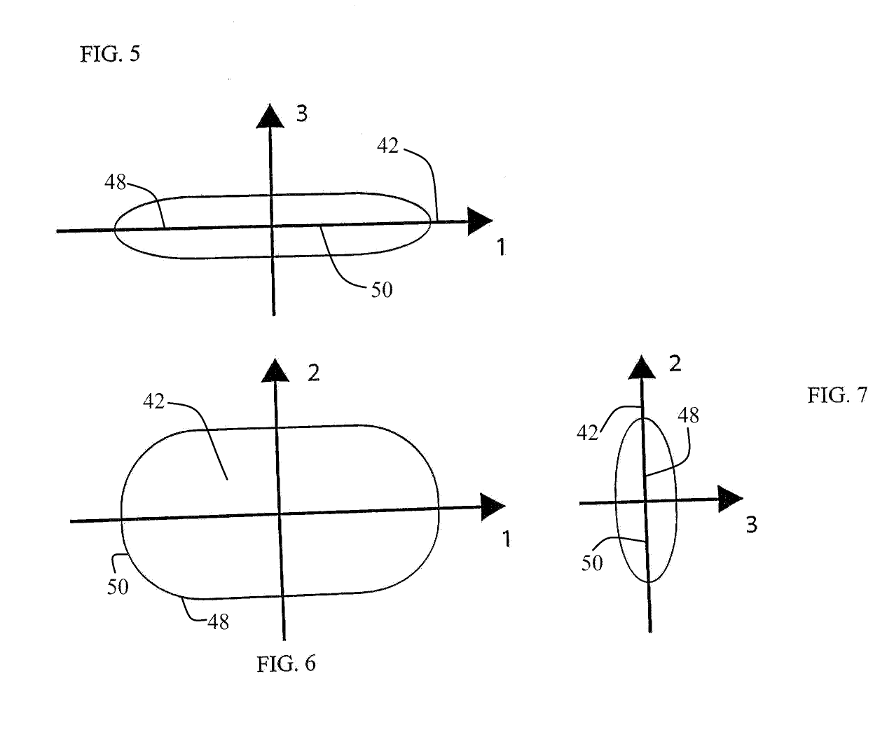

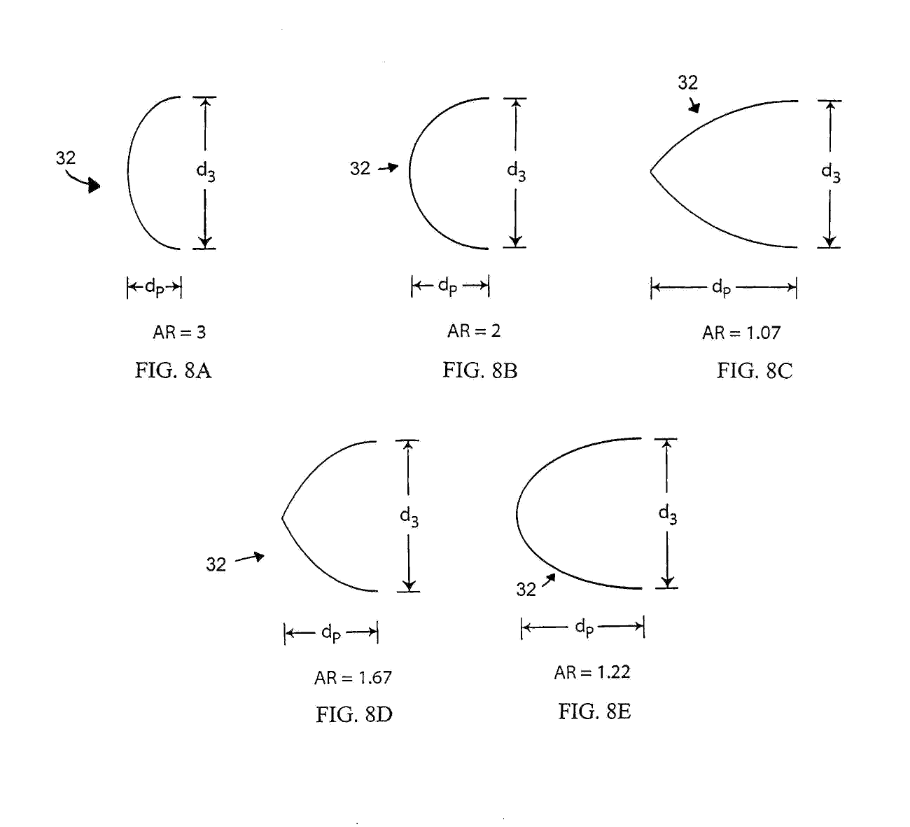

FIGS. 1-4 illustrate a preferred LED floodlight fixture in accordance with this invention. LED floodlight fixture 10 includes two major principal axes (illustrated in FIGS. 5-7 as 1, 2) in a fixture plane 42 (illustrated in FIG. 1). The dimensions parallel to its third principal axis (illustrated in FIGS. 7 and 8 as 3) are substantially smaller than the largest dimensions parallel to fixture plane 42. A simple graphical explanation of the three principal axes (1-3) is shown in FIGS. 5-7.

As best seen in FIGS. 1-3, fixture 10 is characterized by a first outer surface 18 having a first central portion 20 and a first edge-adjacent portion 22, an opposite second outer surface 24 having a second central portion 44 substantially aligned with first central portion 20 and encompassing a light-emitting region 26 and a second edge-adjacent portion 28 having a boundary 46. Second central portion 44 also includes second edge-adjacent portion 28 having a boundary 46 with second central portion 44, such boundary 46 defining a reference plane 34. Reference plane 34 is shown in FIG. 3 as indicated by line 54 with reference plane 34 being perpendicular to the page and containing line 54. Boundary 46 resides in reference plane 34. A simple graphical explanation of principal axes is shown in FIGS. 5 and 7, the drawings illustrate fixture plane 42 in perspective with lines 48, 50 both residing in plane 42 as illustrated in FIG. 1. Also as shown in FIG. 1, perimetrical edge 30 resides in fixture plane 42.

First and second edge-adjacent portions 22, 28 meet a perimetrical edge 30 as illustrated in FIG. 3. As shown in FIGS. 1-3, first and second central portions 20, 44 each extend across at least 25% of the area within perimetrical edge 30. First and second edge-adjacent portions 22, 28 form aerodynamic-drag-reducing cross-sectional profiles 32 transverse to fixture-plane 42 and extend in substantially all in-fixture-plane 42 directions and have aspect ratios of about 3 or less.

Various examples of aerodynamic-drag-reducing cross-sectional profiles 32 are illustrated in FIGS. 8A-8E. FIGS. 8A-8E illustrate that each of the aerodynamic-drag-reducing cross-sectional profiles 32 have an aspect ratio (AR) of about 3 or less. Aspect ration AR as defined above is equal to d₃/d_{P}, and each of the FIGS. 8A-8E indicate these dimensions and a corresponding aspect ratio. All of the profiles illustrated in FIGS. 8A-8E are aerodynamic-drag-reducing cross-sectional profiles 32. Those skilled in the art of aerodynamics will appreciate that certain shapes have lower drag than others and that the aspect ratio is a primary determinant of the aerodynamic drag of a profile. Thus typically, lower aspect ratios are accompanied by lower drag.

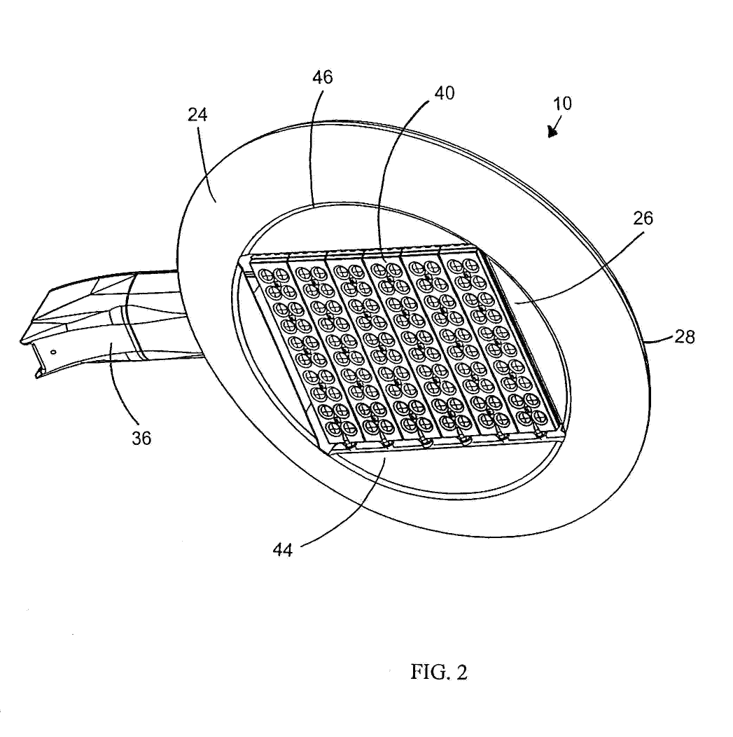

As seen in FIGS. 1-3, the greatest dimension between first central portion 20 and reference plane 34 is no more than 50% greater than the smallest dimension therebetween. Second central portion 44 as illustrated in FIG. 2, can consist of 100% opening but can be also less than 100% opening. Second central portion 44 can also be inset into LED floodlight fixture 10.

As shown in FIG. 1, cross-sectional profiles 32 of fixture 10 are substantially the same. In some embodiments, at least one of first or second edge-adjacent portions 22, 28 is substantially convex. In alternate embodiments both first and second edge-adjacent portions 22, 28 are substantially convex but all of the profiles around the alternate embodiment are not the same. The maximum dimension between first and second edge-adjacent portions 22, 28 in a direction perpendicular to fixture plane 42 occurs between a boundary 52 of first edge-adjacent portion 22 and first central portion 20 and reference plane 34 as seen in FIGS. 1-3.

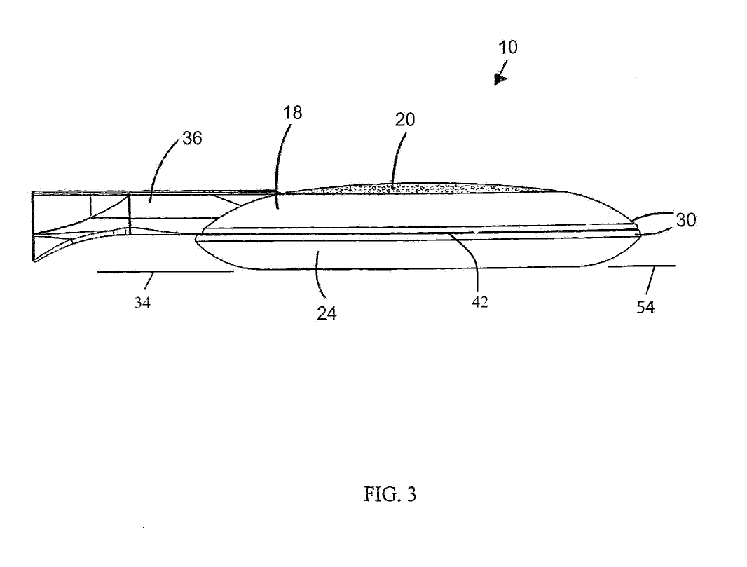

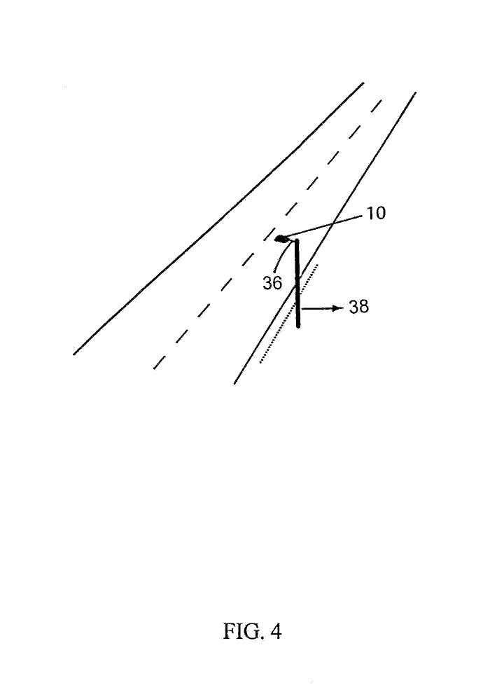

In certain preferred embodiments as shown in FIG. 4, LED floodlight fixture 10 includes pole-mounting assembly 36 which attaches fixture 10 to light pole 38. LED floodlight fixture 10 includes a plurality of LED-array modules 40 fixed in relative positions. Preferably, the pole-mounting assembly 36 has a mounting plate abutting the LED assembly, and at least one fastener/coupler extends from the mounting plate for engagement with the mounting hole of the middle-fin(s) (not shown).

A wide variety of materials are available for the various parts discussed and illustrated herein. While the principles of this invention have been described in connection with specific embodiments, it should be understood clearly that these descriptions are made only by way of example and are not intended to limit the scope of the invention.

1. An LED light fixture comprising:
two major principal axes in a fixture plane, the dimensions of the fixture in planes parallel to its third principal axis being substantially smaller than the largest dimensions parallel to the fixture plane;
a first outer side having a first central portion;
an opposite second outer side having a second central portion substantially aligned with the first central portion and encompassing a light-emitting region including at least one LED-array module supported by an LED heat sink open to air/water-flow; and
a perimetrical structure having first and second edge-adjacent portions meeting at a perimetrical edge and each having a boundary with the respective one of the first and second central portions, the first and second edge-adjacent portions converging toward each other at positions progressively closer to the perimetrical edge to form aerodynamic-drag-reducing cross-sectional profiles transverse to the fixture plane and extending in substantially all fixture-plane directions from the intersection of its two major principal axes, the first and second edge-adjacent portions together having aspect ratios of about 3 or less.

2. The LED light fixture of claim 1 wherein the aspect ratio is about 1.25 or less.

3. The LED light fixture of claim 1 wherein the cross-sectional profiles in substantially all planes containing the third principal axis are substantially the same.

4. The LED light fixture of claim 1 wherein at least one of the edge-adjacent portions is substantially convex.

5. The LED light fixture of claim 4 wherein both the edge-adjacent portions are substantially convex.

6. The LED light fixture of claim 1 wherein:
the boundary between the second central and edge-adjacent portions define a reference plane; and
the maximum dimension between the first and second edge-adjacent portions in a direction perpendicular to the fixture plane occurs between the reference plane and the boundary of the first edge-adjacent portion and the first central portion.

7. The LED light fixture of claim 1 further including a pole-mounting assembly which attaches the fixture to a light pole.

8. The LED light fixture of claim 1 wherein:
the perimetrical structure forms a substantially water/air-tight chamber, the perimetrical structure having the first and second edge-adjacent portions extending therealong; and
at least one electronic LED driver is enclosed within the chamber.

9. The LED light fixture of claim 1 wherein the largest dimensions of the fixture in the plane of the two largest principal axes are substantially equal.

10. The LED light fixture of claim 9 wherein the cross-section in the plane of the two largest principal axes is substantially circular.

11. The LED light fixture of claim 10 wherein the cross-sectional profiles in substantially all planes containing the third principal axes are substantially the same.

12. The LED light fixture of claim 1 wherein the edge-adjacent portions are each convex.

13. An LED light fixture comprising:
a light-emitting region including at least one LED-array module supported by an LED heat sink open for air/water-flow; and
a perimetrical structure having first and second opposite substantially-aligned edge-adjacent portions each extending along the light-emitting region and meeting each other at a perimetrical edge, the first and second edge-adjacent portions converging toward each other at positions progressively closer to the perimetrical edge to form aerodynamic-drag-reducing cross-sectional profiles transverse to the fixture plane and extending in substantially all fixture-plane directions from the intersection of its two major principal axes.

14. The LED light fixture of claim 13 wherein the light-emitting region extending across at least 25% of an area within the perimetrical edge.

15. The LED light fixture of claim 13 wherein at least one of the edge-adjacent portions is substantially convex.

16. The LED light fixture of claim 13 wherein the cross-sectional profiles in substantially all planes containing the third principal axis are substantially the same.

17. The LED light fixture of claim 13 wherein the cross-section in the plane of the two largest principal axes is substantially circular.

18. A pole-mounted light fixture comprising:
two major principal axes in a fixture plane, the dimensions of the fixture in planes parallel to its third principal axis being substantially smaller than the largest dimensions parallel to the fixture plane;
a first outer side comprising a first central portion and a first edge-adjacent portion;
an opposite second outer side comprising (a) a second central portion substantially aligned with the first central portion and encompassing a light-emitting region, the light-emitting region including at least one LED-array module supported by an LED heat sink open for air/water-flow, and (b) a second edge-adjacent portion having a boundary with the second central portion, the boundary defining a reference plane;
a pole-mounting assembly for attaching the fixture to a light pole;
the first and second edge-adjacent portions converging toward each other at positions progressively closer to the perimetrical edge to form aerodynamic-drag-reducing cross-sectional profiles transverse to the fixture plane and extending in substantially all fixture-plane directions from the intersection of its two major principal axes, the first and second edge-adjacent portions together having aspect ratios of about 2 or less; and
the greatest distance perpendicular to the fixture plane between the first central portion and the reference plane is no more than 50% greater than the smallest distance therebetween.

19. The LED light fixture of claim 18 wherein the aerodynamic-drag-reducing cross-sectional profiles extend in substantially all fixture-plane directions from the intersection of its two major principal axes.

20. The LED light fixture of claim 18 wherein the first and second edge-adjacent portions together having aspect ratios of about 3 or less.
